(19) United States
(12) Patent Application Publication
(10) Pub. No.: US 2012/0053813 A1
(43) Pub. Date: Mar. 1, 2012

(54) Method and computer program product for maintaining vehicle inspection, registration, and emissions status

(76) Inventors: Jaclyn A. Karam, Camden, NY (US); William J. Hayes, Remsen, NY (US); Teresa E. Bowman, Rome, NY (US)

(21) Appl. No.: 13/200,033

(22) Filed: Aug. 16, 2011

Related U.S. Application Data
(60) Provisional application No. 61/402,722, filed on Aug. 25, 2010.

(51) Int. Cl. G06F 19/00; G01M 17/00

(52) U.S. Cl. 701/101

(57) ABSTRACT

A method and a computer program product for DoD installations in compliance with the Clean Air Act Section 118 (CAA 118) as well as for collecting, computing, and utilizing carbon footprint data in order to promote sustainability initiatives while supporting security measures at any installation.

### PRIORITY CLAIM UNDER 35 U.S.C. §119(e)

This patent application claims the priority benefit of the filing date of a provisional application, Ser. No. 61/402,722, filed in the United States Patent and Trademark Office on Aug. 25, 2010.

### STATEMENT OF GOVERNMENT INTEREST

The invention described herein may be manufactured and used by or for the Government for governmental purposes without the payment of any royalty thereon.

### BACKGROUND OF THE INVENTION

This invention relates generally to the field of compliance with federally mandated environmental regulations. Specifically, the invention provides a method for compliance with the Clean Air Act, Section 118D. Several federal regulations, executive orders, and Air Force Instructions require vehicle emissions compliance on federal facilities.

CAA Section 118 subpart (c), states that federal agencies “specifically require compliance of federal government vehicles, except for military tactical vehicles, with applicable requirements of a valid state motor vehicle Inspection and Maintenance (I/M) program.”

CAA Section 118 subpart (d) requires that “each department, agency, and instrumentality of the executive, legislative, and judicial branches of the Federal Government having jurisdiction over any property or facility shall require all employees which operate motor vehicles on the property or facility to furnish proof of compliance with the applicable requirements of any vehicle inspection and maintenance program established . . . under part D of this subchapter for the State in which such property or facility is located (without regard to whether such vehicles are registered in the State).”

Air Force Instruction (AFI) 32-7040 Section 3.4.1 states that “Vehicle I/M programs typically apply in areas that do not meet federal ozone (O3) or carbon monoxide (CO) standards. Installations must ensure that either Air Force fleet vehicles, or privately owned vehicles (POVs) operated on the installation, or both, comply with non-discriminatory motor vehicle I/M programs that apply under §118(a) of the Clean Air Act, with the terms of any Memorandum of Agreement (MOA) between DoD and the State (e.g., California), or with any final regulations promulgated by EPA that implement the requirements of §§118(c) or (d) of the Clean Air Act.

Section 3.4.3. of AFI 32-7040 states “E.O. 13423, Strengthening Federal Environmental, Energy, and Transportation Management, establishes federal agency goals for reducing greenhouse gas emissions and the consumption of petroleum—based fuels in fleet vehicles. Relative to fiscal year 2005 baselines, agencies are required to: reduce the consumption of petroleum-based fuels by 2% annually through 2015; increase the consumption of non-petroleum-based fuels by 10% annually; and acquire and use plug-in hybrid (PIH) technology vehicles when they are commercially available at a life-cycle cost that is reasonably comparable to non-PIH vehicles. Installations are directed to begin establishing sustainable environmental, energy and transportation practices that will assist the Air Force in meeting the federal goals of E.O. 13423 through the implementation or expansion of initiatives such as carpooling, use of public transportation, trip reduction techniques, and wider use of alternative fuels in fleet vehicles.”

What is lacking in the prior art is a method for tracking compliance with Clean Air Act (CAA) Section 118 and other mandated reporting and compliance monitoring in an automated, intelligent fashion.

### OBJECTS AND SUMMARY OF THE INVENTION

One object of the present invention is to provide a method to capture vehicle emission registrations for all federally employed persons driving to and from any federal installation location.

Another object of the present invention is to provide a method to generate data on greenhouse gas, or carbon footprint resulting from federal employee travel.

Yet another object of the present invention is to provide a method for security forces to view vehicle/employee information in order to improve security measures on federal installations.

The invention disclosed herein (also referred to as Vehicle Air Maintenance Program: Inspection, Registration and Emissions or “VAMPIRE”) provides a method and a computer program product for solving multiple issues in one database. In particular, this invention puts DoD (e.g., “base”) and other federal installations in compliance with the CAA 118 issue as well as allows carbon footprint data to be collected and utilized in order to promote sustainability initiatives and supports security measures at any installation or property that uses this program. The present invention is not limited to federal agencies and can be adapted to state, county, or agency of a governmental subdivision, as well as for private organizations.

### BRIEF DESCRIPTION OF THE DRAWINGS

FIG. 1.1 depicts the front end of the steps implemented by the present invention. This is the “main menu” upon entering the software application embodiment of the present invention.

FIG. 2.1 depicts all of the actions an administrator can perform using the present invention including the present invention's steps which implement government vehicle solution to CAA 118 non-compliance.

FIG. 2.2 depicts the present invention's steps which implement government vehicle mileage flow which allows the carbon footprint to be stored for each government vehicle.

FIG. 2.3 depicts the present invention's steps which implement a base vehicle search by the user.

FIG. 2.4 depicts the present invention's steps that permit a user to view all defense switch network (DSN) flow.

FIG. 2.5 depicts the present invention's steps that permit all makes and models of vehicles to be viewed, edited, added or deleted by the user.

FIG. 2.6 depicts the present invention's steps that permit a user to update the US Counties table with their associated I/M compliance based on the base location. US Counties flow.

FIG. 2.7 depicts the VAMPIRE master flow steps that permit all information in the present invention to be accessed.

FIG. 2.8 depicts the present invention's steps that permit a user to generate a listing of all vehicles within a 50 miles radius from a base zip code.

FIG. 2.9.1 depicts the present invention's steps that permit a user to generate various administrative reports including delinquent inspection listings.

FIG. 2.9.2 depicts the present invention's steps that permit a user to generate e-mail inspection notifications.

FIG. 2.9.3 depicts the present invention's steps that permit a user to generate e-mail recertification notices.

FIG. 2.9.4 depicts the present invention's steps that permit a user to create an emissions listing.

FIG. 2.9.5 depicts the present invention's steps that permit a user to create a compliance listing for government vehicles.

FIG. 2.9.6 depicts the present invention's steps that permit a user to create a compliance listing for private vehicles.

FIG. 2.9.7 depicts the present invention's steps that permit a user to create a non-certified listing for all vehicles.

FIG. 3.1 depicts the present invention's steps that permit a user interface to the customer vehicles menu including the present invention's steps that permit a user to input all drivers' vehicle information.

FIG. 4.1 depicts the present invention's steps which implement the security police menu including the present invention's steps that permit security police to lookup vehicle information.

FIG. 5.1 depicts the present invention's steps which implement the System Administrator menu including the data dictionary and definitions functions.

FIG. 5.2.1 depicts the present invention's steps which implement the management of base user records.

FIG. 5.2.2 depicts the present invention's steps which implement the end of year program.

FIG. 5.2.2.2 depicts the present invention's steps which implement the inspection expiration notification function.

FIG. 5.2.2.3 depicts the present invention's steps which implement the recertify notification function.

### DETAILED DESCRIPTION OF THE PREFERRED EMBODIMENT

VAMPIRE (Vehicle Air Maintenance Program: Inspection, Registration and Emissions Program), as the present invention is referred to, was conceived after an Environmental finding for Clean Air Act (CAA) Section 118 non-compliance was reported in 2008 by Hanscom AFB, MA. The finding was then distributed to all Air Force Material Command (AFMC) Air Quality Managers and the Air Force Research Laboratory Information Directorate (AFRL/RI) took the initiative to solve the problem. The original purpose of the present invention was to provide an automated work process which solves the CAA 118 non-compliance issue. During the conceptualization stage it was realized that the software implementation (i.e., program) of the invention had the potential to solve multiple issues that would in addition, save time and money. This program was designed to automatically fill in many forms with information that is already known to the system, preventing errors and saving man hours. It provides many reports, listings and pre defined queries that are otherwise unavailable. The present invention is configured so that databases can be linked together without modifying the code of the original program. Data is pushed, pulled and streamlined into processes according to the aforementioned regulations that are built into the application's workflow.

### CAA 118 Compliance:

The method employed by the present invention follows the format prescribed within the EPA Interim Guidance for Federal Facility Compliance with CAA Sections 118(c) and 118(d) and Applicable Provisions of State Vehicle Inspection and Maintenance Programs of December 1999. Applicable federal facilities need to ensure compliance with vehicle inspection and maintenance (I/M) programs within their states and counties. The present invention provides the Department of Defense (DoD) and other federal agencies an easily accessible, low maintenance, regulatory driven program that will implement the goals of the CAA, EPA and DoD together. Some of the advantages of the present invention are:
Automated Process
Minimal Effort to Enforce—Automatic updates on which employees have completed and certified inspection/maintenance (I/M) compliance
Same periodic checks needed as with decal procedure
Certificates automatically created in database.
Yearly reminders for employees to update.
Automatic Compliance with new employees
Data can be pushed into APIMS for scope 1 & 3 emission inventory
Easily expandable and can convert to new requirements.
Out of state compliance verification, if not in compliance automatically updates VAMPIRE manager.
Automated warning of expiration notice.
Allows identification of employees traveling from common locations.
Linked to GHG calculations, Vehicle Profiles, GSA . . . etc—Allows for automatic updates on set basis (daily, monthly . . . etc)
Allows for one common system to be used throughout AF.
Allows Air Staff/DoD to access database and have information at their fingertips.
Security can access database.
Database solves more than just I/M problem.
Currently, all government (GSA Leased) vehicles are loaded into the system and mileage is inserted monthly in order to track our fleet carbon footprint.
VAMPIRE uses DOD approved PKI single-sign authentication that is CAC enabled.
The privacy act/perjury statements are both incorporated into the program to ensure compliance and accuracy.

### Green House Gases:

This invention supports Executive Orders (EO) 13423/13514 in that it can calculate carbon footprints from facility vehicle travel and employee commuting. The invention yields several reports which could assist in implementing alternative transportation measures by analyzing the need for public transportation based on the demographics of the facilities commuters. This allows facilities to reduce their fossil fuel consumption and emissions by establishing alternative options for transportation.

### Site Security:

This feature of the present invention enhances security at a facility by allowing authorized vehicles on site that are not decaled. Security officers can look up vehicles by any available field to ensure compliance with the local I/M laws as well as augmenting current badge checks. A future aspect of the program is hoped to include a license plate scanner that can automatically tell the security police if the vehicle has access to the site.

The present invention (i.e., VAMPIRE) is a working program at AFRL/RI and can be deployed on any Oracle web-enabled database. The system is currently tracking government fleet vehicles but could track employee vehicles as well.

The present invention has been tested fully and is ready to move forward in order to use it to its full potential. The first version of VAMPIRE was integrated into AFRL/RI's logistics system and the current system is a stand-alone and can be pushed on any Oracle system. AFRL/RI is very willing and ready to complete a technology transfer with any company or government agency that wishes to utilize the accomplishments of the present invention. Since employee vehicle information is not being tracked yet, AFRL/RI security forces have not been using the invention, but have indicated they will utilize the invention once it is deployed.

Additionally, the present invention establishes the capability to generate automatic emails and reports for non-compliance with CAA 118D and GHG information. These emails can be sent to the employee, their supervisor or the installation commander (in the case of federal facilities). Automatic emails are also sent for reminders and yearly certifications.

At AFRL/RI, Rome, N.Y. the system has been linked to the Rome Research Site (RRS) Personnel Table in order to enhance the efficiency and authentication of the system. The hope for other installations is to link to their own personnel table and utilize the system in the same efficient manner.

### Cost Savings:

VAMPIRE, the present invention, will serve to avoid a significant amount of fines and penalties. The EPA could fine up to $32,500/day or $295,000/year max for non-compliance with this regulation. The Department of Defense (DoD) has been out of compliance since 1995. That fine could potentially be $295,000.00*15 years=$4,400,000.00 per installation, DoD wide. There will also be a cost savings in the amount of time it would take for each installation to come up with their own program. Since VAMPIRE has already been developed, it saves the federal government a large amount of money instead of outsourcing the development via contract.

### Future Enhancements:

Public Transportation Module
Privacy Act Information Module—Allows Security or anyone with authorized clearance to view PAI. All other Master users will only be allowed to calculate for GHG emissions. ALL PAI will be blocked out. This will allow for very accurate calculations.
Exact emissions factors for each vehicle along with exact average gas mileage per vehicle.
Link to a .gov site that has a listing of all vehicles and their gas mileage (i.e., fueleconomy.gov)
Could apply NOx Sox . . . etc into calculation to give not only carbon footprint but GHG total footprint . . . (i.e., Mobile 6)
Security—hook up a camera to the gated entrance that can detect the license plate and provide clearance to a vehicle through the program.

The present invention brings DoD installations in compliance with the CAA 118. This invention also assists security police with enforcing compliance and maintaining a secure perimeter. This invention also captures vehicle emissions in order to provide a tool for reductions in greenhouse gases.

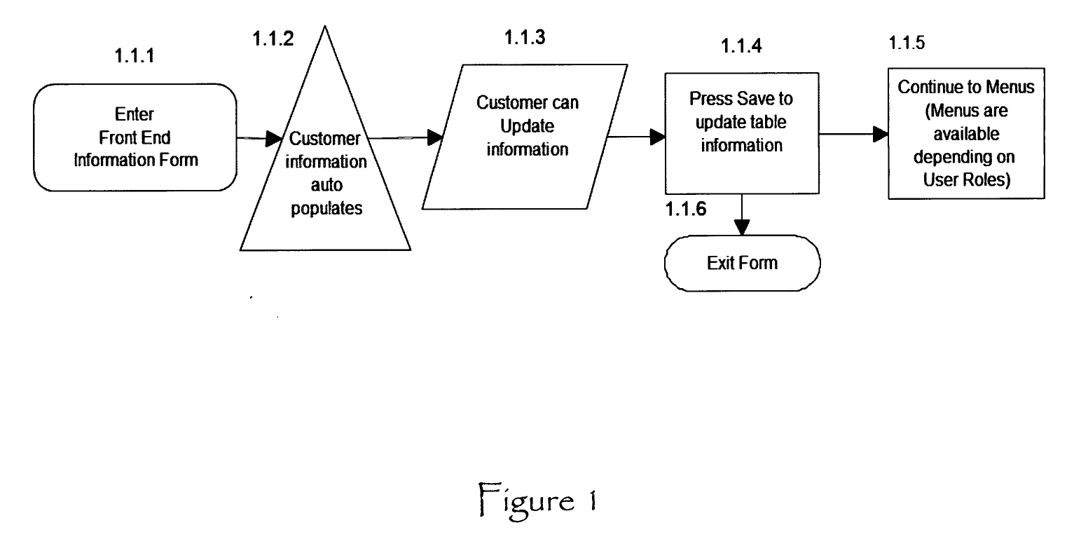

Referring to FIG. 1.1, the front end of the present invention is the initial access point into the system. Specifically, each numerically-referenced flowchart step depicted in FIG. 1.1 performs the associated functions as follows:
1.1.1 Users enter the front end information form.
1.1.2 User information auto populates.
1.1.3 A user can update information in green fields.
1.1.4 User presses save to update table information.
1.1.5 User has the option to move on to the vehicle section
1.1.6 The user can exit.

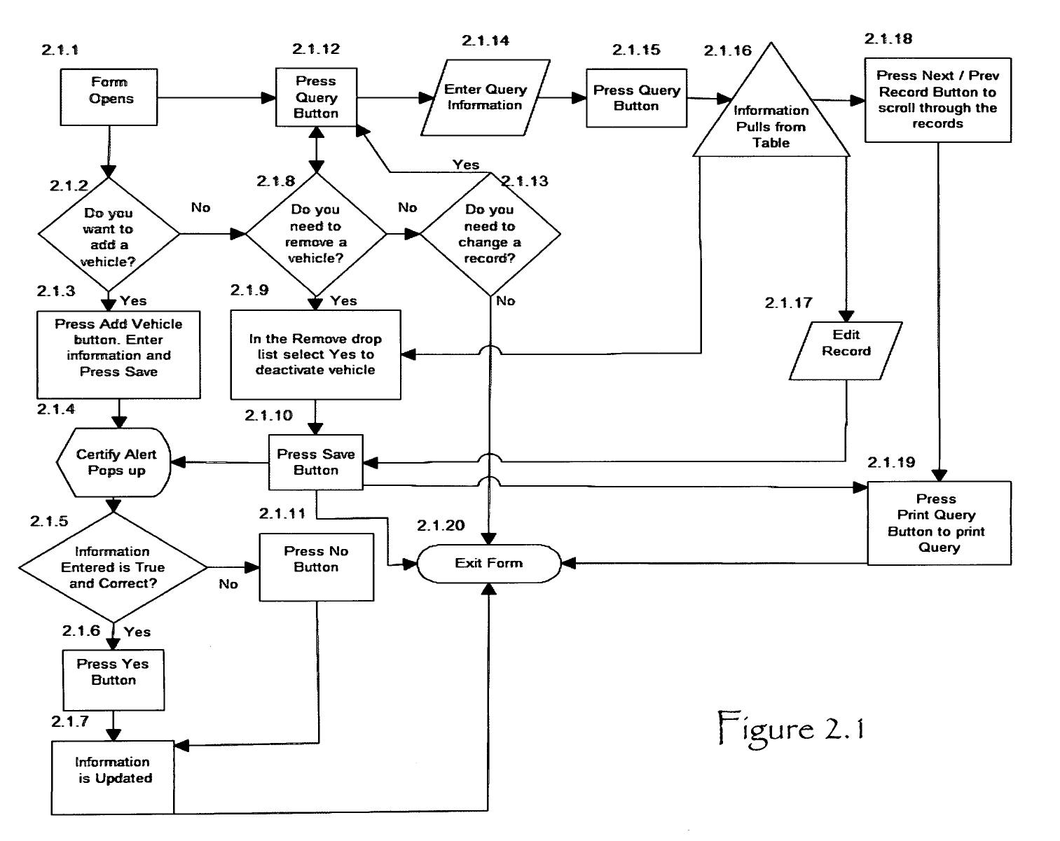

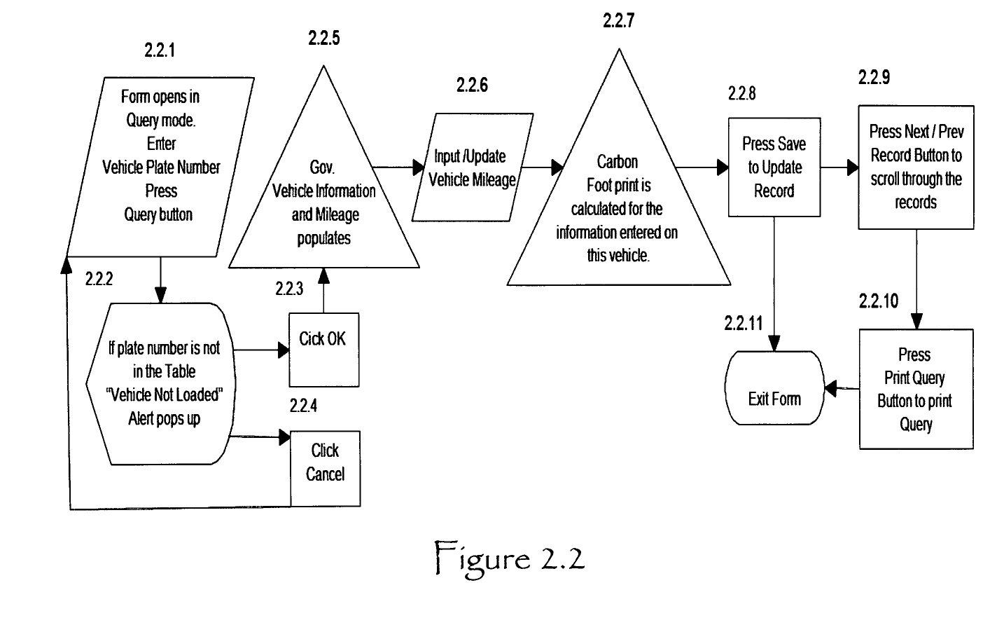

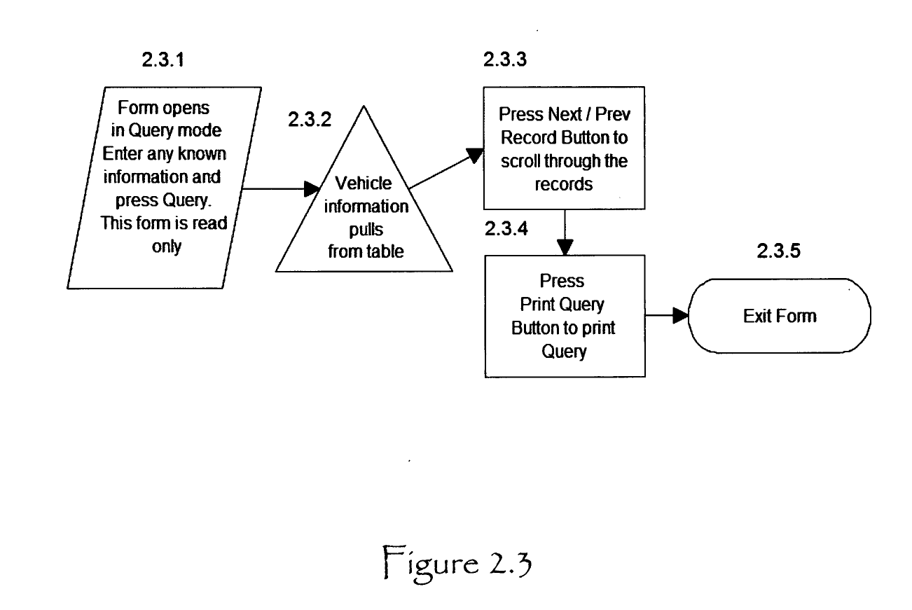

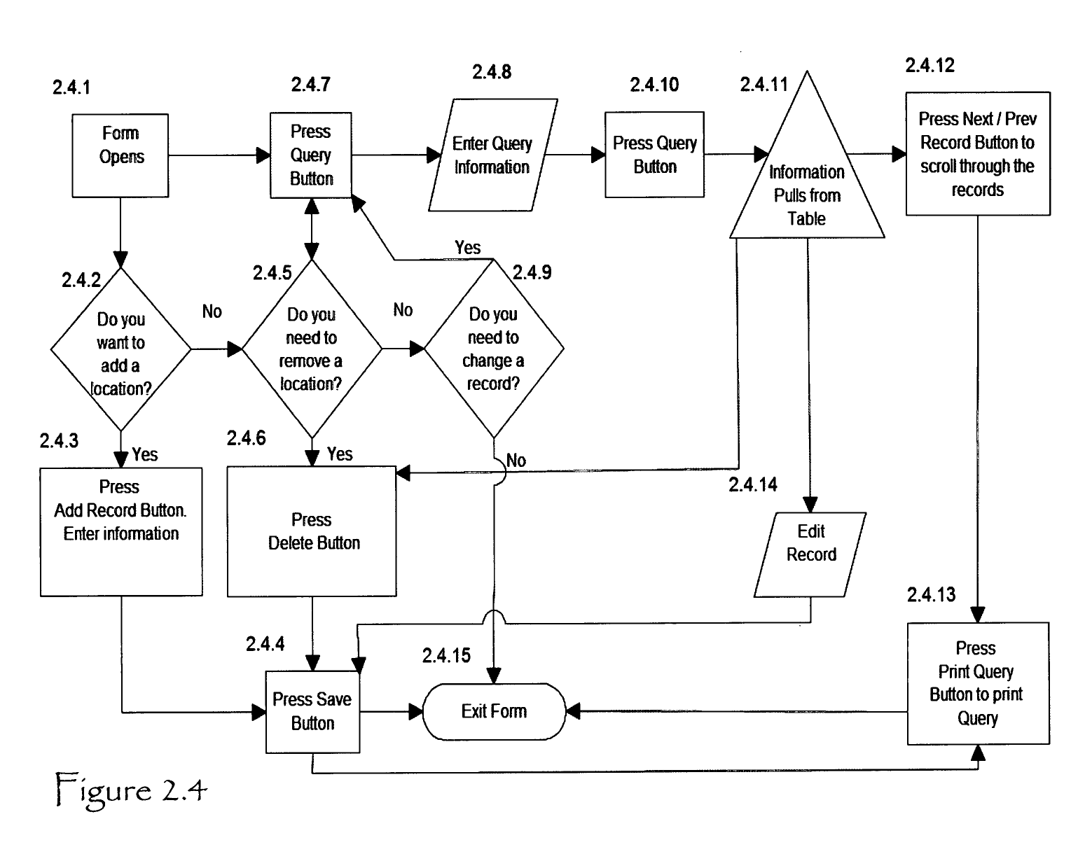

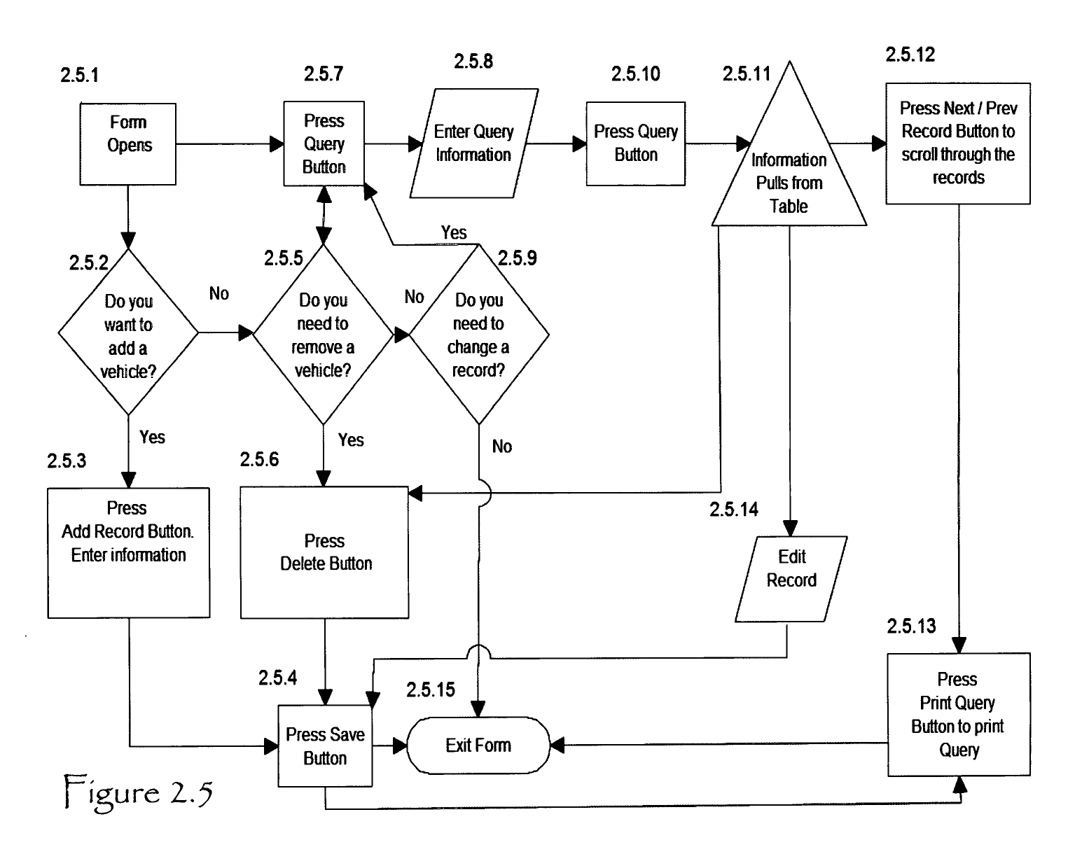

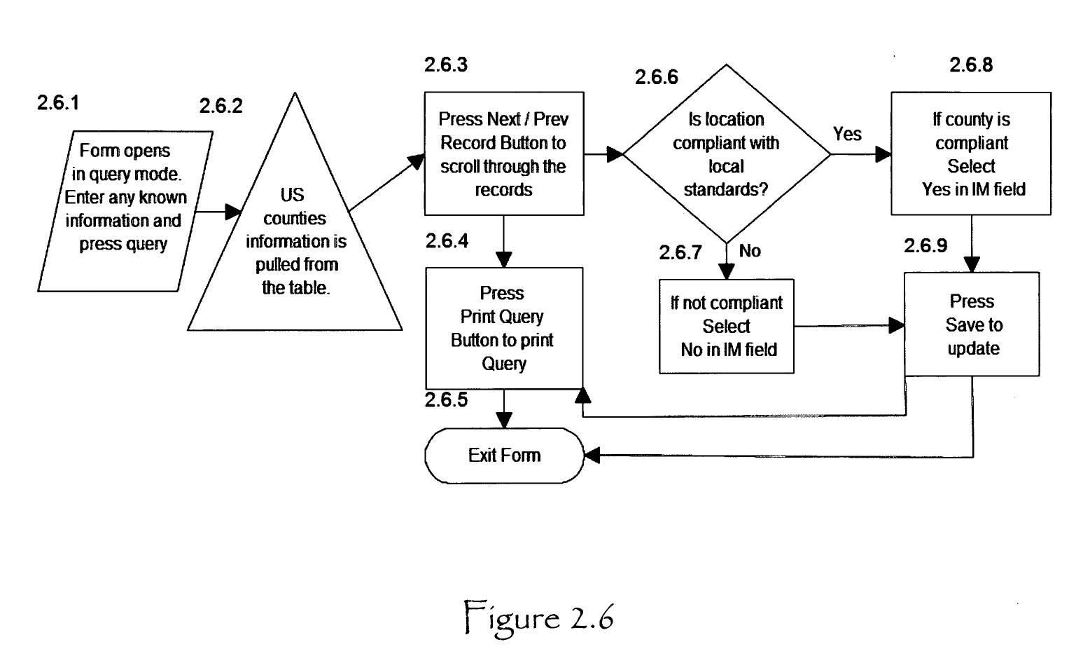

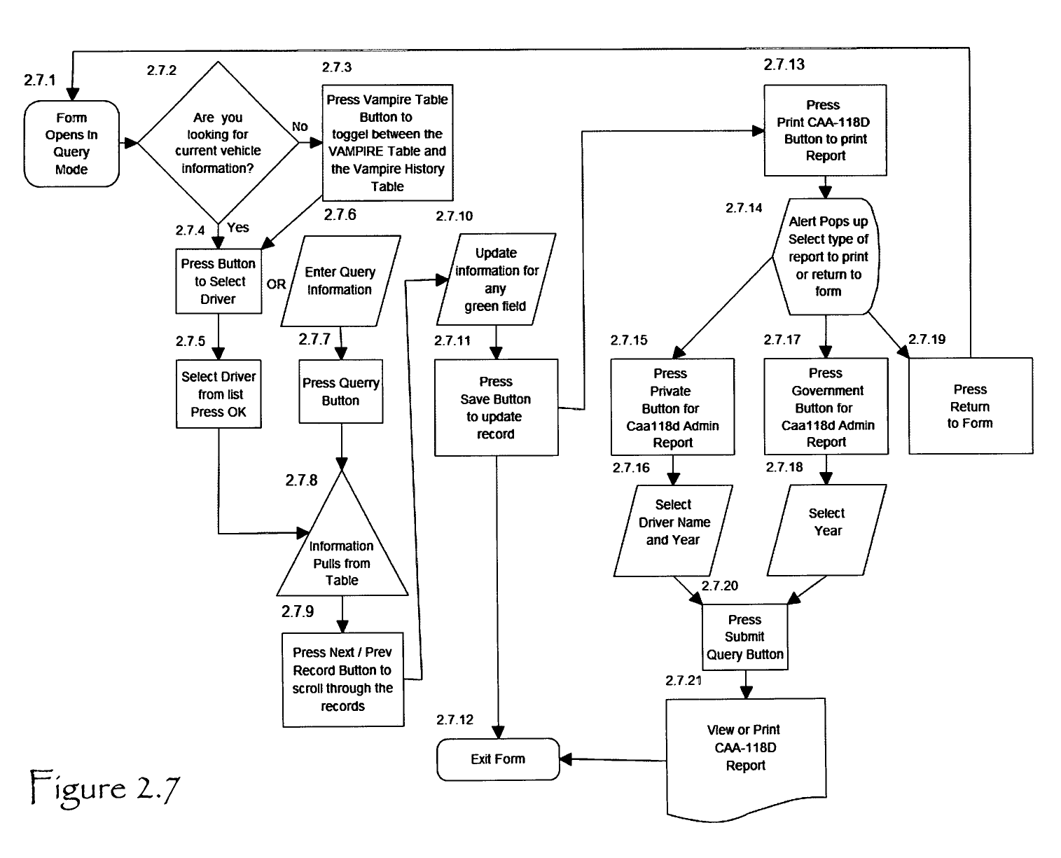

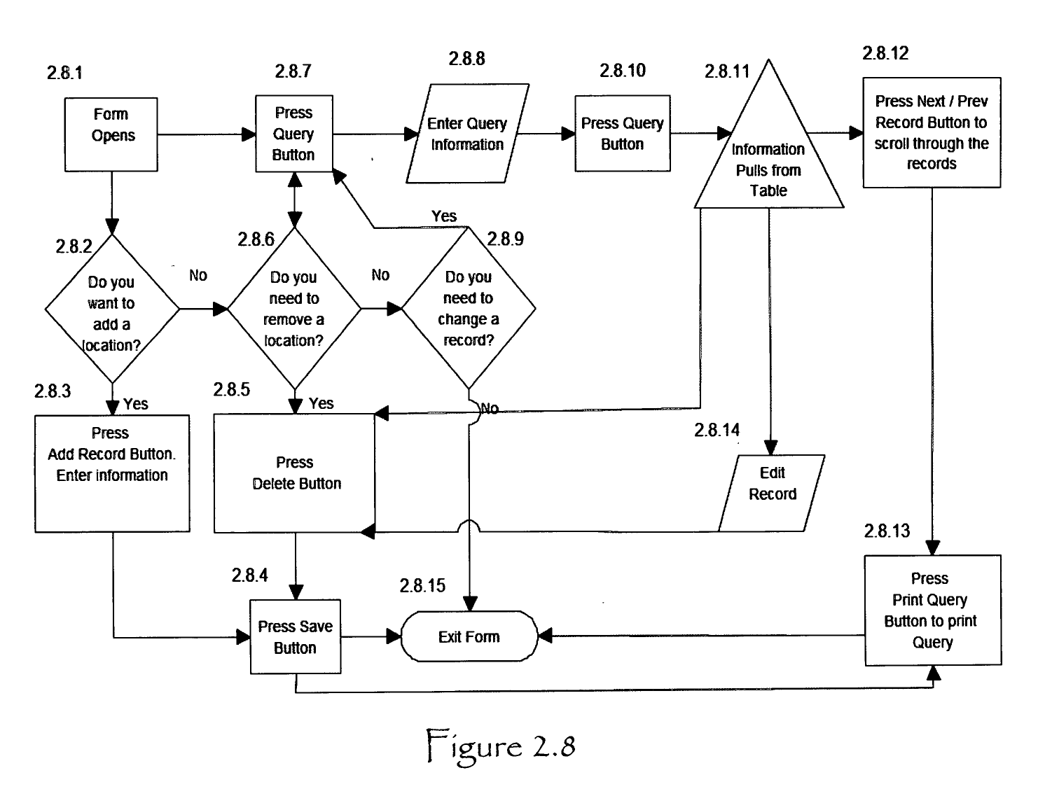

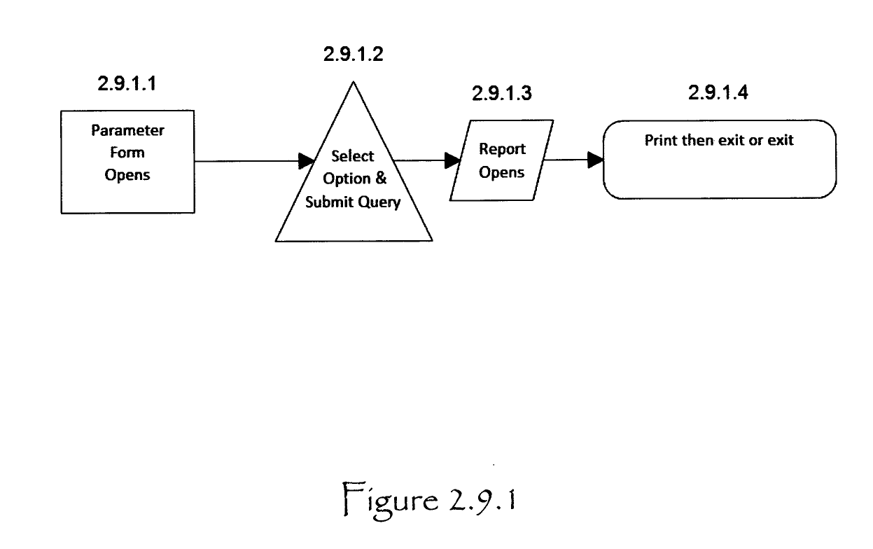

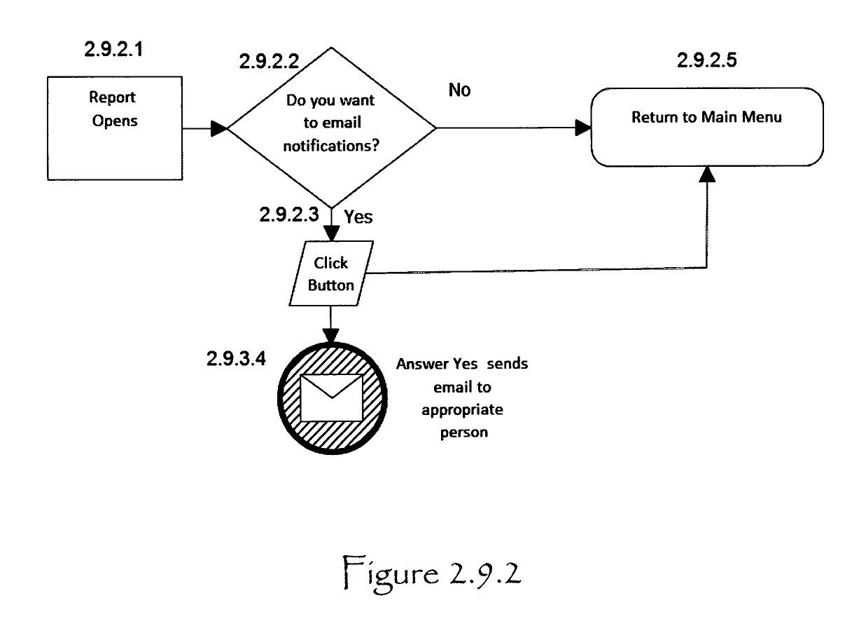

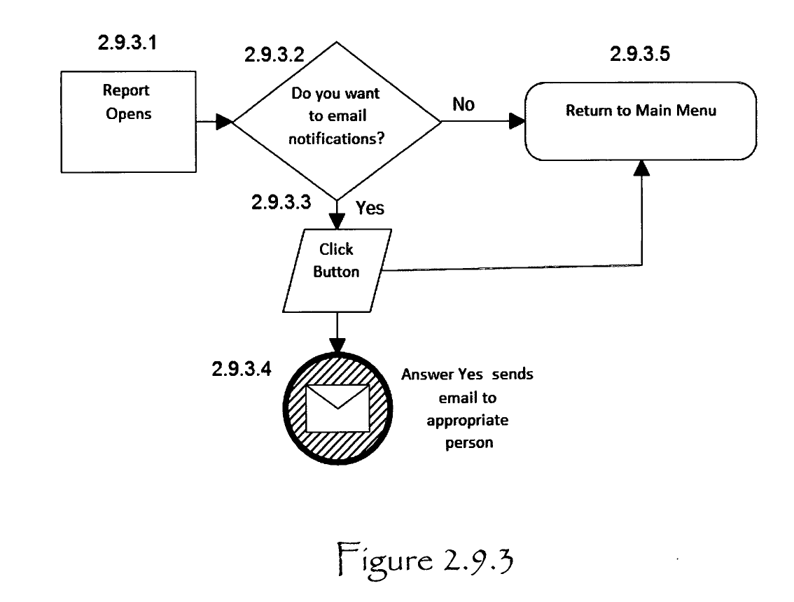

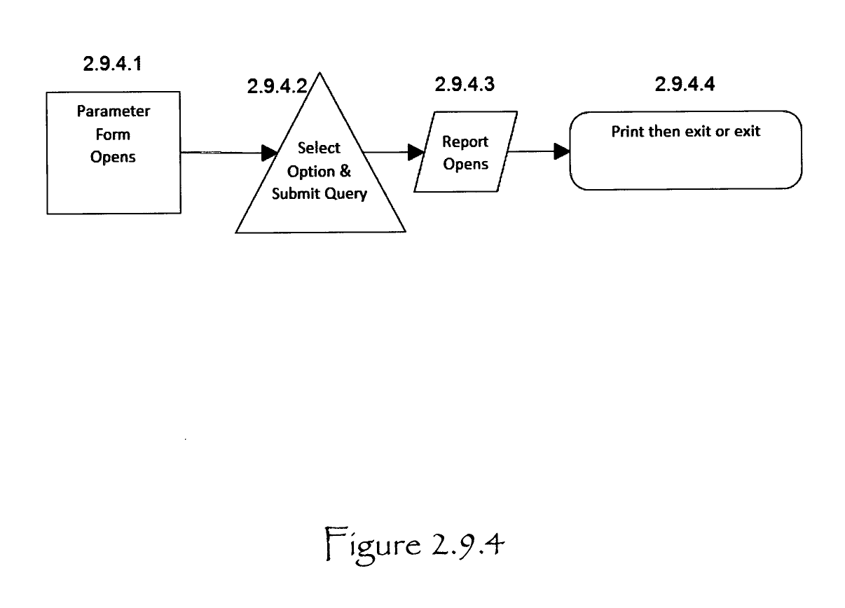

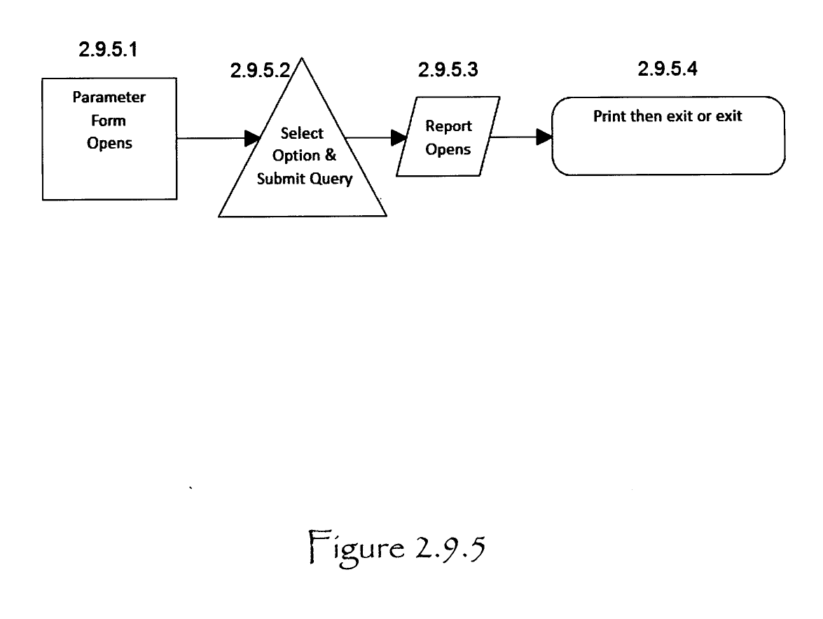

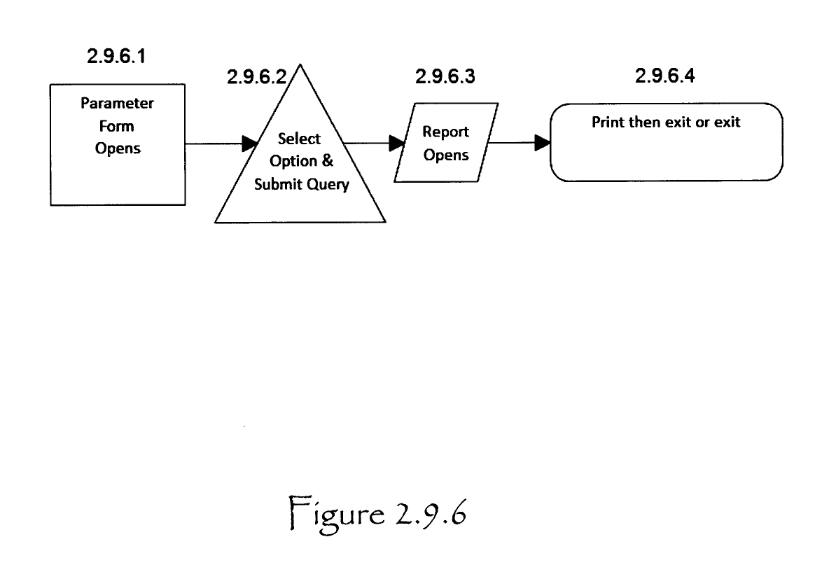

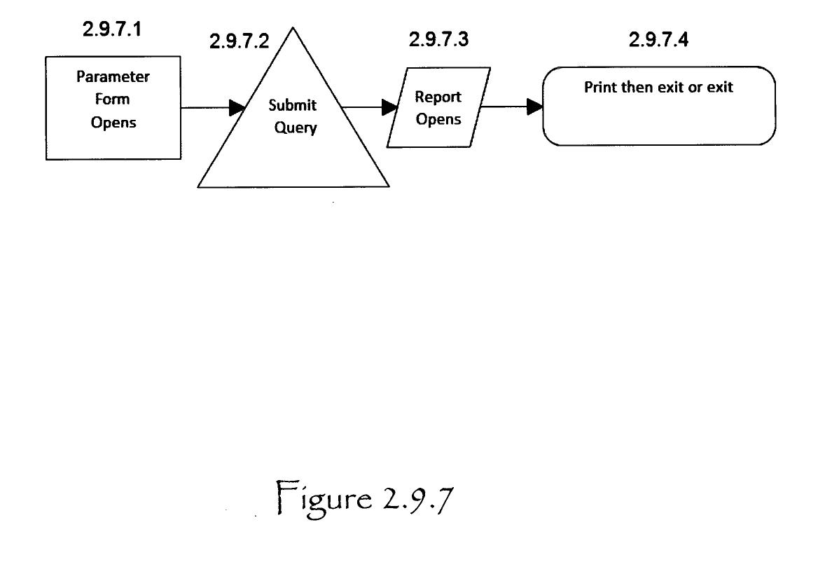

Referring to FIG. 2.1 depicts all the administrative actions the present invention performs. These actions include input of data for government vehicles and their associated mileage, access to employee base vehicle information, DSN information across AF, management of makes and models of vehicles, logging of compliance information for US counties according to the base (or facility) location, calculating emissions along with analyzing if public transportation would provide greater value, according to radius from a particular zip code. The reports screen and Vampire Master screen allows managers to access data and verify certifications and methods of compliance for users. Specifically, each numerically-referenced flowchart step depicted in FIG. 2.1 performs the associated functions as follows:
2.1.1. Form opens in query mode.
2.1.2. Do you want to add a vehicle?
2.1.3. Hit Add Vehicle and enter the following information: Plate#, Year, Vehicle Make/Model/Color/Fuel Type, MPG, Garage Zip. Manager also notates where the vehicle is a scientific or tactical vehicle, if it has a waiver that exempts it from passing an emission test. You then certify all information is true and can add another vehicle, etc.
2.1.4. Certify Alert Pops up
2.1.5. Information entered is true and correct?
2.1.6. Press Yes
2.1.7. Information is updated
2.1.8. Do you want to remove a vehicle from operation?
2.1.9. Select Yes, in the remove field.
2.1.10. Save information to database.
2.1.11. Press No
2.1.12. Press Query Button
2.1.13. Do you need to change a record?
2.1.14. Enter query information
2.1.15. Hit Query button to view all vehicles in the system, or enter specific available and query
2.1.16. Vehicle information will populate from table.
2.1.17. Edit record
2.1.18. Hit previous/next to toggle through search through results.
2.1.19. Press Print Query button to print queried results

Referring to FIG. 2.2 depicts the actions the present invention performs with regard to government vehicle mileage flow, including allowing the carbon footprint to be stored for each government vehicle. The present invention provides a form to enter monthly mileage used for government vehicles. The form is a query only. Users perform queries by the Plate Number of the vehicle. Users then enter the mileage for that month and save the record. After mileage for the month of December is entered, the query will start the new year with January being the first record. If no plate number is entered and the query button is pressed, no records will be queried because the user must enter a plate number. Specifically, each numerically-referenced flowchart step depicted in FIG. 2.2 performs the associated functions as follows:
2.2.1 Form opens in query mode. Hit Query button, or enter specific plate number.
2.2.2. If plate number is not in the Table “Vehicle Not Loaded” Alert pops up.
2.2.3. Click OK
2.2.4. Click Cancel
2.2.5. Vehicle information and mileage will populate from p_vampire table.
2.2.6. Input or update mileage.
2.2.7. Carbon footprint is automatically calculated using data entered in the p_vampire table.
2.2.8. Save information to database
2.2.9. Hit previous/next to toggle through search through results.
2.2.10. Press Print Query button to print queried results
2.2.11. Exit Form

Referring to FIG. 2.3 depicts the actions the present invention performs to allow the manager to search vehicles by: Plate Number, Year, State of Registration, Make, Model and color along with Driver information including Name, Phone, Office, Building, Room or email. Specifically, each numerically-referenced flowchart step depicted in FIG. 2.3 performs the associated functions as follows:
2.3.1. Form opens in query mode. Hit Query button twice, or enter specific available and search through results.
2.3.2. Vehicle/Driver information will populate from p_vampire table,
2.3.3. Hit previous/next to toggle through search through results.
2.3.4. Press Print Query button to print queried results
2.3.5. Exit Form

Referring to FIG. 2.4 depicts the actions the present invention performs to allow managers to see all Defense Switched Networks (DSN) outside the continental United States (OCONUS) Air Force. The invention allows DSN's to be added or deleted from the system. Specifically, each numerically-referenced flowchart step depicted in FIG. 2.4 performs the associated functions as follows:
2.4.1. Form opens in query mode.
2.4.2. Do you want to Add a new DSN?
2.4.3. Press Add button, Input information and check certify.
2.4.4. Save and commit.
2.4.5. Do you need to removed a record?
2.4.6. Highlight field and press delete button, Verify deletion.
2.4.7. Press query button
2.4.8. Enter specific Location, DSN or commercial number, if known
2.4.9. Do you need to change a record?
2.4.10. press query once.
2.4.11. Vehicle information is pulled from the system based on query entered or if no information was queried will populate all DSNs.
2.4.12. To scroll through data press next/previous record or hit print Query to get a listing of DSNs. Any updates or additions can be completed.
2.4.13. Press query button to print query
2.4.14. Edit record
2.4.15. Exit

Referring to FIG. 2.5 depicts the actions the present invention performs to allow to all makes and models of vehicles to be viewed, edited, added or deleted. Specifically, each numerically-referenced flowchart step depicted in FIG. 2.5 performs the associated functions as follows:
2.5.1. Form opens in query mode.
2.5.2. Do you want to Add a new make and model?
2.5.3. Press Add button, Input information and check certify.
2.5.4. Save and commit.
2.5.5. Do you need to remove a record?
2.5.6. Highlight field and press delete button, Verify deletion.
2.5.7. Press query button
2.5.8. Enter specific make and model, if known
2.5.9. Do you need to change a record?
2.5.10. press query once.
2.5.11. Vehicle information is pulled from the system based on query entered or if no information was queried will populate all makes and models.
2.5.12. To scroll through data press next/previous record or hit print Query to get a listing of makes and models. Any updates or additions can be completed.
2.5.13. Press print query button to print query
2.5.14. Edit record
2.5.15. Exit

Referring to FIG. 2.6 depicts the actions the present invention performs to allow the managers to update the US Counties table with their associated I/M compliance based on the base location. Specifically, each numerically-referenced flowchart step depicted in FIG. 2.6 performs the associated functions as follows:
2.6.1. Form opens in query mode. Hit Query button twice to view all listings or enter specific State/County, if known and query.
2.6.2. US Counties/State information is pulled from the table.
2.6.3. Hit next/previous record to scroll through other data and check next counties standards.
2.6.4. Press print query button to print query
2.6.5. Exit Form
2.6.6. Is state/county in question compliant with the local standards? (For instance. If the base is located in New York and the State/County in question is Greene County, Utah, are the standards for Greene County meeting or exceeding New York States?)
2.6.7. If not compliant select NO from the drop down list next to the associated county.
2.6.8. If compliant select YES from the drop down list next to the associated county.
2.6.9. Press Save to commit any changes.

Referring to FIG. 2.7 depicts the actions the present invention performs to allow all information in the system to be accessed, including: Driver information: Name, phone, DSN, office, Building, Room, Email, Home Location and creation date; whether the employee is a federal employee, assigned to the installation more than 180 days per year, and drives on federal property or park on federal property more than 60 days per year; and Vehicle information including: Year, Make, Model, Color, Plate, State/County/Registration Expiration, Garage Zip, Method of Compliance, MPG for vehicle, Months used out of the year, Miles to base, based on zip code, if vehicle has been removed. Specifically, each numerically-referenced flowchart step depicted in FIG. 2.7 performs the associated functions as follows:
2.7.1. Form opens in query mode.
2.7.2. Are you looking for current vehicle information?
2.7.3. Press Vampire Table Button to Toggle between the VAMPIRE Table and the Vampire History table.
2.7.4. Press button to select driver
2.7.5. Select driver from list and press ok.
2.7.6. Enter query information
2.7.7. Hit Query button
2.7.8. Driver/Vehicle information populates from tables.
2.7.9. Hit next/previous record to scroll through other data.
2.7.10. Update any green fields and certify. Note this changes the last certification name to the vampire masters, not the users. You can scroll through each employee/gov't vehicle by using next/previous record.
2.7.11. Press Save Button to update record
2.7.12. Exit Form
2.7.13. Hit print CAA-118D
2.7.14. Alert Pops-
2.7.15. select private
2.7.16. select driver name and year
2.7.17. Press government button
2.7.18. Select year
2.7.19. Press Return to Form
2.7.20. Press submit query button.
2.7.21. Report can be viewed and printed.

Referring to FIG. 2.8 depicts the actions the present invention performs to allow a listing of all vehicles within a 50 miles radius from base zip code. This can be extended to any range. Specifically, each numerically-referenced flowchart step depicted in FIG. 2.8 performs the associated functions as follows:
2.8.1. Form opens in query mode.
2.8.2. Do you want to Add a new zip code?
2.8.3. Press Add button, Input information and check certify.
2.8.4. Save and commit.
2.8.5. Highlight field and press delete button, Verify deletion.
2.8.6. Do you need to remove a record?
2.8.7. Press query button
2.8.8. Enter specific zip code or location, if known
2.8.9. Do you need to change a record?
2.8.10. Press query once.
2.8.11. Zip code information is pulled from the system based on query entered or if no information was queried will populate all zip codes in system.
2.8.12. To scroll through data press next/previous record or hit print Query to get a listing of zip codes. Any updates or additions can be completed.
2.8.13. Press print query button to print query
2.8.14. Edit record
2.8.15. Exit

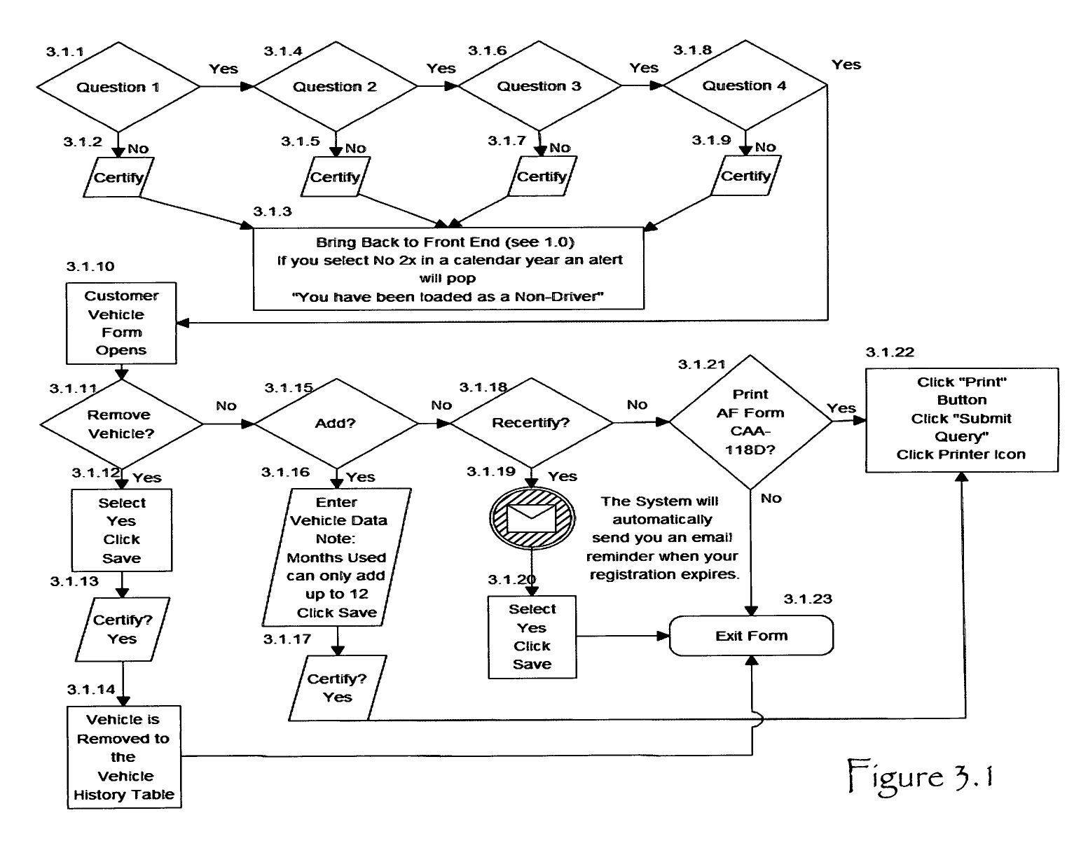

Referring to FIG. 2.9 depicts the actions the present invention performs to include the execution of the following administrative reports: Delinquent Vehicle Inspection Listing; a Listing of all drivers and their supervisors that have the following conditions on the expiration dates: 30 Days before Expiration, 1 Thru 29 Days after Expiration, 30 Thru 59 Days after Expiration, 60 Thru 89 Days after Expiration, 90 Days after Expiration; and Email Inspection Expiration Notifications. This form was created for the System Manager to send out email Notifications of Driver vehicles that have expired inspections. Notifications go out to the Driver, Driver's Supervisor and Drivers Installation Commander depending on the length of time that the inspection has been expired. The invention Emails the Driver that inspection will expire within 30 days, Emails the Driver and the Driver's supervisor if inspection has been expired for 89 days or less, and Emails the Driver, and Driver's Commander that inspection has been expired for over 90 days. The invention sends an Email Recertify Notification to the Driver that he/she must recertify their vehicle for the new calendar year. The invention creates an Emissions Listing which is a listing of records from the p_vampire_view view. The invention has three setup parameters as follows: 1) Type Report: All Vehicles, Base Vehicles or Government Vehicles; 2) Order by: Any Column selected, and 3) Calendar Year: Year Total is the sum of the tons of CO₂ emissions. The invention generates a Method of Compliance Government Vehicle Listing having two parameters, Method of Compliance and Year. The compliance government vehicle listing displays the private vehicle drivers and reason why they are compliant. The invention also generates a Method of Compliance Private Vehicle Listing having two parameters, Method of Compliance and Year. The compliance private vehicle listing displays the private vehicle drivers and reason why they are compliant. The invention also generates a Vehicles not Certified Listing which is a listing of all drivers that have not Certified their Vehicle for the New Year or have not entered a Vehicle. Specifically, each numerically-referenced flowchart step depicted in FIG. 2.9 performs the associated functions as follows:
2.9.1. Delinquent Vehicle Inspection Listing: Listing of all drivers and their supervisors that have the following conditions on the expiration dates: 30 Days before Expiration, 1 Thru 29 Days after Expiration, 30 Thru 59 Days after Expiration, 60 Thru 89 Days after Expiration, 90 Days after Expiration.
   2.9.1.1. Parameter report opens
   2.9.1.2. Select option and Submit query
   2.9.1.3. Report opens
   2.9.1.4. Print then exit or exit
2.9.2. Email Inspection Expiration Notifications: Allows System Manager to send out email Notifications of Driver vehicles that have expired inspections. Notifications go out to the Driver, Drivers Supervisor and Drivers Installation Commander depending on the length of time that the inspection has been expired. Emails Driver that inspection will expire within 30 days, Emails Driver and Driver's supervisor if inspection has expired and is within 89 days. Emails Driver, and Drivers Commander that inspection has expired over 90 days.
   2.9.2.1. Report opens
   2.9.2.2. Do you want to email notifications?
   2.9.2.3. Answer yes to verify
   2.9.2.4. Sends email to appropriate person based on delinquency date
   2.9.2.5. Return to menu
2.9.3. Email Recertify Notifications: The recertify email notifies the Driver that he/she must recertify their vehicle for the new calendar year.
   2.9.3.1. Report opens
   2.9.3.2. Do you want to email notifications?
   2.9.3.3. Answer yes to verify
   2.9.3.4. Sends email to appropriate person based on delinquency date
   2.9.3.5. Returns to menu
2.9.4. Emissions Listing: Creates a listing of records from the p_vampire_view view. We have setup 3 parameters as follows: 1) Type Report: All Vehicles, Base Vehicles or Government Vehicles 2) Order by: Any Column selected 3) Calendar Year: Year. Total is the sum of the tons of co2 emissions.
   2.9.4.1. Select options
   2.9.4.2. Select query
   2.9.4.3. List populates from table
   2.9.4.4. Print and exit or exit
2.9.5. Method of Compliance Government Vehicle Listing: Listing has two parameters, Method of Compliant and Year. Report displays the private vehicle drivers and reason why they are compliant.
   2.9.5.1. Select options
   2.9.5.2. Submit query
   2.9.5.3. Print and exit or exit
2.9.6. Method of Compliance Private Vehicle Listing: Listing has two parameters, Method of Compliant and Year. Reports the private vehicle drivers and reason why they are compliant.
   2.9.6.1. Select options
   2.9.6.2. Submit query
   2.9.6.3. Print and exit or exit
2.9.7. Vehicles not Certified Listing: Listing of all Drivers that have not Certified their Vehicle for the New Year or have not entered a Vehicle.
   2.9.7.1. Submit query
   2.9.7.2. Print and exit or exit
Referring to FIG. 3.1 depicts the actions the present invention performs to allow all base drivers data to be input into the Vehicle Air Maintenance Program. The opening form populates the p_vampire table. The base driver can query, insert and update records only. The CAA 118D form will be an Air Force (AF) form that displays the Government Employee's driver information with Privacy Act and Certification under Penalty of Perjury statements. Form has two parameters. First is the Electronic Data Interchange Personal Identifier (EDIPI) which is passed via the parent form that executes the report which is the :global.edipi. Second parameter is the drop down list of Years. Customer Vehicles: Base Drivers data input form for Vehicle Air Maintenance Program. Form populates the p_vampire table. Base Driver can query, insert and update records only

Specifically, each numerically-referenced flowchart step depicted in FIG. 3.1 performs the associated functions as follows:
3.1.1. Are you a federal employee
3.1.2. Certify and save
3.1.3. Loops back to front end where you can print CAA118-D form
3.1.4. Are you primarily assigned to the installation more than 180 days per year?
3.1.5. Certify and save
3.1.6. Do you operate a private vehicle on federal property?
3.1.7. Certify and save
3.1.8. Do you park a vehicle on federal property more than 60 days per year?
3.1.9. Certify and save
3.1.10. Customer Vehicle Input Screen opens and driver information is automatically populated from table.
3.1.11. Do you want to remove a vehicle?
3.1.12. Select yes from the Remove vehicle drop down
3.1.13. Certify by selecting Yes (if no brings you back to vehicle screen).
3.1.14. Vehicle moves into the removed vehicles section and is added to the history table
3.1.15. Do you want to add a vehicle?
3.1.16. Enter vehicle data: Year, Make, Model, Color, Plate #, State, County and Inspection Expiration date, garage zip, months used (total<=12), estimated mpg, fuel type. If zip code is wrong or not entered in the system, the Program creates a notification email that is sent to the Vampire Admin and System Manager if the RRS Driver does not enter a zip code or the zip code that they entered is not in the p_vampire_radiuszip table. The Vampire Admin will then find the right zip code and enter it into the p_vampire_radiuszip table via the p_vampire_radiuszip_form.fmb. Program is executed from the vampire_customer_form.fmb on the pre-insert and pre-update triggers. If county and state of vehicle is out of compliance with base state, then Program creates a notification email that is sent to the Vampire Admin and System Manager if the Base Driver Answers “No” to Alert “Did you get a vehicle Emissions Inspection in New York state?”. When Vampire Manager receives the email they will take corrective action and code the Base Drivers Vehicle record im_compliant field with “B” via the p_vampire_master_form.fmb mail_vampire_non_compliant_ltr.sql is executed from the p_vampire_customer_form.fmb on the state_regis when-validate-item trigger.
3.1.17. Certify by selecting yes
3.1.18. Would you like to recertify an existing vehicle?
3.1.19. System automatically sends out an e-mail reminder when registration expires
3.1.20. Select Yes and save
3.1.21. Would you like to print the CAA118-D form?
3.1.22. Click Print, submit query and click printer icon
3.1.23. Exit form

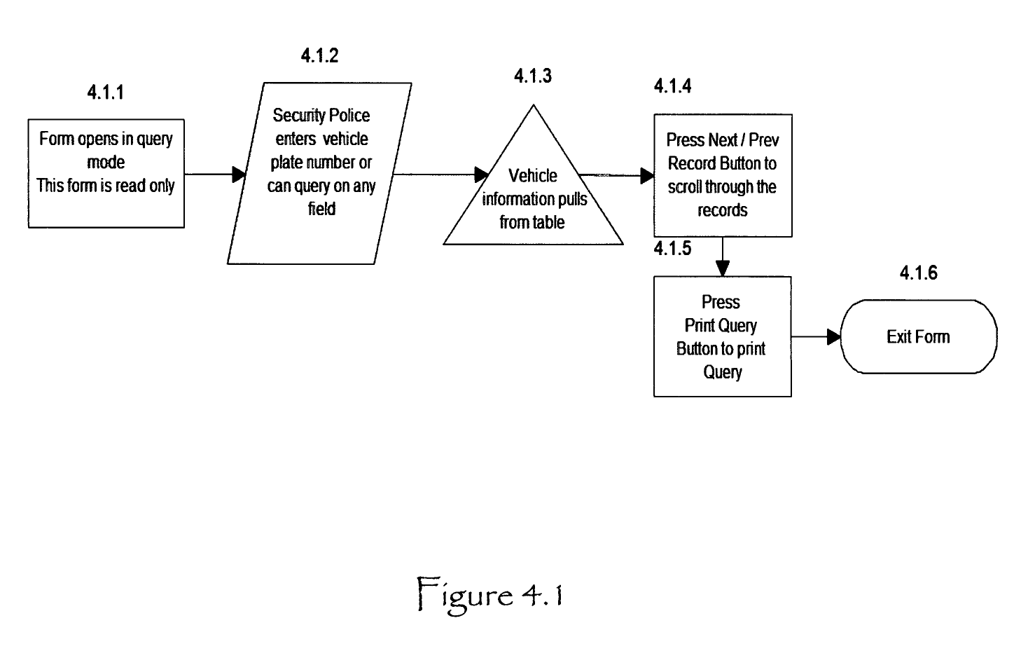

Referring to FIG. 4.1 depicts the actions the present invention performs to allow security police to access vehicle information which ensures security measures for incoming vehicles on base. Allows manager to search vehicles by: Plate Number, Year, State of Registration, Make, Model and color along with Driver information: Name, Phone, Office, Building, Room or email. Security office can query by any field to see if vehicle is valid in the system and also shows a vehicle picture as an extra enhancement. This feature ensures compliance and increased safety of installation borders. Specifically, each numerically- referenced flowchart step depicted in FIG. 4.1 performs the associated functions as follows:
4.1.1. Form opens in query mode. Hit Query button twice, or enter specific available and search through results.
4.1.2. Vehicle/Driver information will populate from table, allows you to click through records if more than one agrees with inputted query.
4.1.3. Exit Form

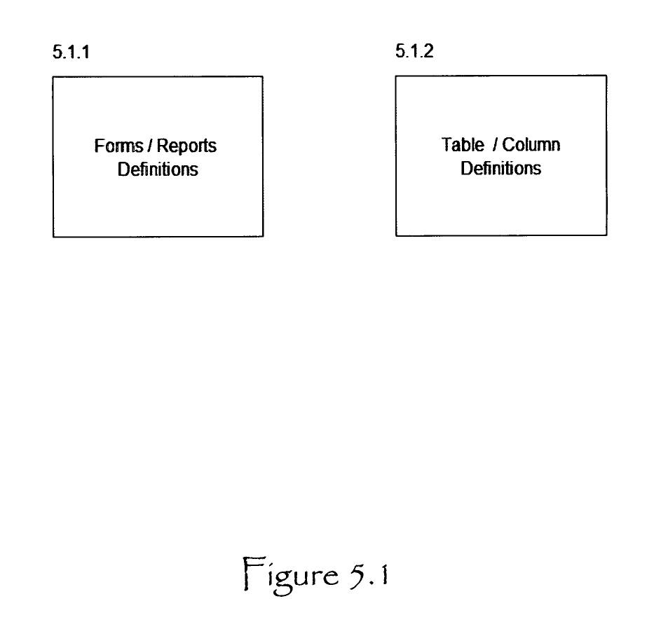

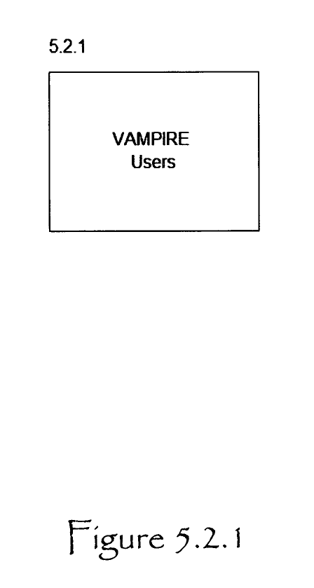

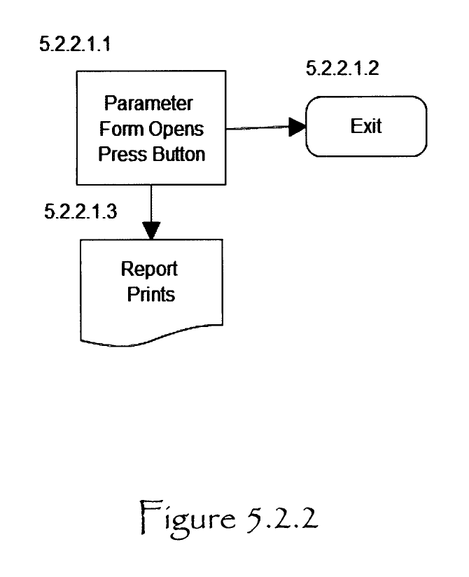

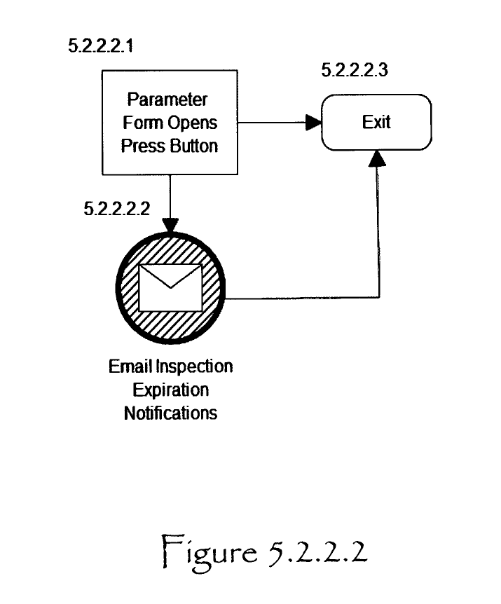

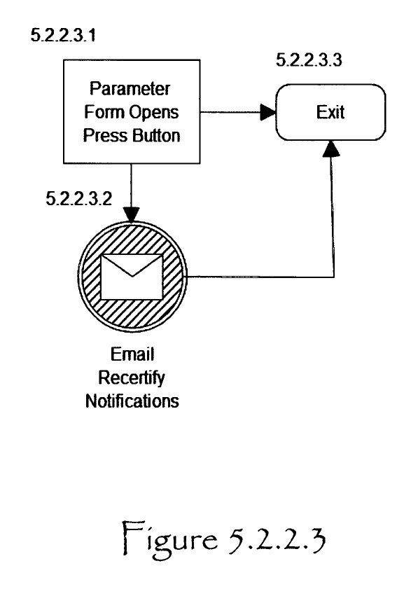

Referring to FIG. 5.1 depicts the actions the present invention performs to include the data dictionary functions: Forms/Reports Definitions and Table/Column Definitions. Forms/Reports Definitions: Form allows the System manager to query on menus, sub menus, options on menus and form/report name to find their definitions. When new forms or reports are added to Vampire, the System manager needs to define it using this form. This form uses Lists of Values (LOVs) to help the user enter the same menu names and options. Menu options are LOVs selected from the p_vampire_frms_rpts_defs table. Table/Column Definitions: Form has two blocks the table_defs and column_defs. This form was created so the system manager can work on the table and column definitions at one time. Table and column list columns are pulled from the p_vampire_tabs_cols table. If a new table or a column is added to a table then p_vampire_tabs_cols table must behave the records deleted and the following code executed: insert into p_vampire_tabs_cols select table_name, column_name, data_length, data_type from cols; this is done so the table names and column names will be added to the list columns table_name and column_name. Specifically, each numerically-referenced flowchart step depicted in FIG. 5.1 performs the associated functions as follows:
5.1.1. Forms/Reports Definitions: Form allows the System manager to query on menus, sub menus, options on menus and form/report name to find their definitions. When new forms or reports are added to Vampire, the System manager needs to define it using this form. This form uses LOVs to help the user enter the same menu names and options. Menu options are LOVs selected from the p_vampire_frms_rpts_defs table.
5.1.2. Table/Column Definitions: Form has two blocks the table_defs and column_defs. This form allows the system manager to work on the table and column definitions at one time. Table and column list columns are pulled from the p_vampire_tabs_cols table. If a new table or a column is added to a table then p_vampire_tabs_cols table must behave the records deleted and the following code executed: insert into p_vampire_tabs_cols select table_name, column_name, data_length, data_type from cols; This is done so the table names and column names will be added to the list columns table_name and column_name.

Referring to FIG. 5.2.1, FIG. 5.2.2, FIG. 5.2.2.2, and FIG. 5.2.2.3 depicts the actions the present invention performs to include the system manager menus including the Vampire Users and Reports. The Vampire users form allows the System Manager to manage the base users records in the p_vampire_users table. It also allows the manager to update records, insert new users, delete users and give special privileges to users such as: Admin: gives access to Admin Menu; Security: gives access to Security Police Menu; Sysman: Give access to ALL menus; User: gives access to Customers menu. After updating users information in the p_vampire_users table all other tables with user information are updated also thru a database trigger. See p_vampire_db_triggers.sql. The reports include executing the end of year program, email inspection expiration notices and emailing recertification notices. Specifically, each numerically-referenced flowchart step depicted in FIG. 5.2.1, FIG. 5.2.2, FIG. 5.2.2.2, and FIG. 5.2.2.3 performs the associated functions as follows:

Referring to FIG. 5.2.2, steps 5.2.2.1.1 through 5.2.2.1.3 perform Execute End of Year Program—This executable file is to be executed on the first of every January via the p_vampire_eoy.fmb form. Program updates the following tables to set up for the new year. After running the driver must re-certify their vehicles for the new year.
5.2.2.1.1 Parameter form opens, press button
5.2.2.1.2 Exit
5.2.2.1.3 Report prints

Referring to FIG. 5.2.2.2, steps 5.2.2.2.1 through 5.2.2.2.3 execute the Inspection Expiration Notifications—This form was created for the System Manager to send out email Notifications of Driver vehicles that have expired inspections. Notifications go out to the Driver, Drivers Supervisor and Drivers Installation Commander depending on the length of time that the inspection has been expired.
5.2.2.2.1 Parameter form opens, press button
5.2.2.2.2 Email Inspection Expiration Notifications Sends.
5.2.2.2.3 Exit

Referring to FIG. 5.2.2.3, steps 5.2.2.3.1 through 5.2.2.3.3 execute the Recertify Notifications—The recertify email notifies the Driver that he/she must recertify their vehicle for the new calendar year.
5.2.2.3.1 Parameter form opens, press button
5.2.2.3.2 Email Recertify Notification Sends.
5.2.2.3.3 Exit

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. A method for maintaining vehicle inspection, registration and emissions status comprising a sequence of computer-implementable instructions stored on a non-transitory computer-readable medium, wherein, when said computer-executable instructions are executed by a computer, said computer-executable instructions cause said computer to:
retrieve vehicle specific information;
verify vehicle certifications of compliance;
compute vehicle carbon footprint;
associate a vehicle with vehicle operator's phone number;
view, add, edit, and delete vehicles;
generate a form CAA-118D;
list all vehicles within a specified radius;
generate delinquent vehicle inspection listings;
e-mail inspection expiration notifications;
e-mail recertification notifications;
perform a security vehicle search using specified query parameters;
perform system manager queries; and
execute an end of year program.

2. The method of claim 1 wherein said step of retrieving vehicle specific information further comprises the step of auto-populating said information.

3. The method of claim 1 wherein said step of verifying vehicle certifications of compliance further comprises the step of adding or removing a vehicle record.

4. The method of claim 1 wherein said step of computing vehicle carbon footprint further comprises the steps of:
computing the number of possible work days per year;
computing the total number of work days per year by subtracting holidays, vacation days, and sick days from said number of possible work days per year;
setting the number of days a vehicle is driven to work site per year equal to the total number of work days per year;
computing the round trip mileage between the vehicle's point of origin and the work site;
computing the total yearly vehicle mileage by multiplying said round trip mileage by said total number of work days per year;
computing total yearly vehicle fuel consumption by dividing said total vehicle mileage per year by said vehicle miles per gallon fuel consumption;
WHEN said vehicle is gasoline powered,
computing the total yearly pound-mass of carbon dioxide emitted by said vehicle by multiplying said total yearly vehicle fuel consumption by 19.4 pounds per gallon;
OTHERWISE
when said vehicle is diesel fuel powered,
computing the total yearly pound-mass of carbon dioxide emitted by said vehicle by multiplying said total yearly vehicle fuel consumption by 22.2 pounds per gallon;
computing the yearly tons-mass of carbon dioxide emitted by said vehicle by dividing said yearly pound-mass of carbon dioxide emitted by 2000 pounds per ton.

5. A computer program product encoded in a non-transitory computer-readable medium for instructing a computer system to maintain and monitor vehicle inspection, registration, and emissions status, the computer program product comprising:
a front-end information module for generating an interactive main menu;
an administrator module;
a government vehicle mileage flow and carbon footprint module;
a vehicle search module;
a Defense Switched Network module;
a vehicle make and model module;
a U.S. counties module;
a master flow module;
a zip code search module;
a delinquent vehicle inspection module;
an e-mail vehicle inspection notification module;
a vehicle emissions listing module;
a vehicle compliance listing module; and
a security police vehicle information lookup module;
wherein said administrator module, government vehicle mileage flow and carbon footprint module, vehicle search module; Defense Switched Network module, vehicle make and model module; U.S. counties module; master flow module; zip code search module; delinquent vehicle inspection module; e-mail vehicle inspection notification module; vehicle emissions listing module; vehicle compliance listing module; and security police vehicle information lookup module are linked to each other through said front-end information module so as to facilitate data interchange therebetween.

6. The computer program product of claim 5 wherein said front-end information module provides an initial access point to a user for entering and updating information.

7. The computer program product of claim 5 wherein said administrator module provides access to vehicle and employee information, verify vehicle certifications, and verify methods of vehicle emissions compliance.

8. The computer program product of claim 5 wherein said vehicle mileage flow and carbon footprint module tracks monthly vehicle mileage; and
calculates a carbon footprint for each said vehicle by performing the steps of:
computing the number of possible work days per year;
computing the total number of work days per year by subtracting holidays, vacation days, and sick days from said number of possible work days per year;
setting the number of days a vehicle is driven to work site per year equal to the total number of work days per year;
computing the round trip mileage between the vehicle's point of origin and the work site;
computing the total yearly vehicle mileage by multiplying said round trip mileage by said total number of work days per year;
computing total yearly vehicle fuel consumption by dividing said total vehicle mileage per year by said vehicle miles per gallon fuel consumption;
WHEN said vehicle is gasoline powered,
computing the total yearly pound-mass of carbon dioxide emitted by said vehicle by multiplying said total yearly vehicle fuel consumption by 19.4 pounds per gallon;
OTHERWISE
when said vehicle is diesel fuel powered,
computing the total yearly pound-mass of carbon dioxide emitted by said vehicle by multiplying said total yearly vehicle fuel consumption by 22.2 pounds per gallon;
computing the yearly tons-mass of carbon dioxide emitted by said vehicle by dividing said yearly pound-mass of carbon dioxide emitted by 2000 pounds per ton.

9. The computer program product of claim 5 wherein said vehicle search module performs a vehicle search by any one of the following: license plate number, year, state of registration, make, model, color, or driver information.

10. The computer program product of claim 5 wherein said Defense Switched Network (DSN) module performs vehicle and operator search according to said operator's DSN telephone number.

11. The computer program product of claim 5 wherein said vehicle make and model module performs the addition, deletion, editing, and viewing of all vehicles.

12. The computer program product of claim 5 wherein said U.S. counties module tracks county-specific vehicle inspection/maintenance (I/M) emissions compliance standards in whichever county a base is located.

13. The computer program product of claim 5 wherein said master flow module performs access to all vehicle and vehicle driver information and driver employment information and status.

14. The computer program product of claim 5 wherein said zip code search module performs a search of all vehicles assigned to a base within a specific radius from a zip code associated with said base.

15. The computer program product of claim 5 wherein said delinquent vehicle inspection module performs a determination of vehicle inspection expiration at specific days prior to and after vehicle inspection expiration.

16. The computer program product of claim 5 wherein said e-mail vehicle inspection notification module e-mails inspection expiration notifications to vehicle owners.

17. The computer program product of claim 5 wherein said vehicle emissions listing module computes the yearly total of carbon dioxide emissions for any said vehicle.

18. The computer program product of claim 5 wherein said compliance listing module generates a compliance listing for government fleet vehicles and privately-owned vehicles; and
generates a basis for said compliance of both said government fleet and privately-owned vehicles.

19. The computer program product of claim 5 wherein said security police vehicle information lookup module which:
performs vehicle and vehicle owner searches; and
retrieves a photo of said vehicle.
